(19) United States
(12) Patent Application Publication
(10) Pub. No.: US 2005/0099619 A1
(43) Pub. Date: May 12, 2005

(54) Large area, high quality print scanner apparatus

(75) Inventors: George W. McClurg, Jensen Beach, FL (US); John F. Carver, Palm City, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/640,688

(22) Filed: Aug. 14, 2003

Related U.S. Application Data
(60) Provisional application No. 60/402,917, filed on Aug. 14, 2002.

(51) Int. Cl. G06K 9/74

(52) U.S. Cl. 356/71; 358/474; 250/556

(57) ABSTRACT

The present invention relates to systems and methods for biometric object image capturing. More specifically, the present invention relates to systems and methods for generating large area, high-quality images. An embodiment of the present invention comprises a sliding mechanical stage and a plurality of sensors mounted on the sliding mechanical stage. At least one sensor generates a large area a preview image. Another sensor generates a large area high quality image.

### BACKGROUND OF THE INVENTION

1. Field of the Invention

The present invention relates to the field of live print scanning.

2. Related Art

Traditionally, techniques for obtaining a print image have included application of ink to a person's fingertips, for instance, followed by rolling or simply pressing the tips of the individual's fingers to appropriate places on a recording card. This technique can be very messy due to the application of ink, and may often result in a set of prints that are difficult to read.

Today, print scanning technology includes electro-optical devices for capturing images of a print pattern found on a biometric object, such as a finger, a palm, a foot, etc. In such instances, the electro-optical device may be a fingerprint scanner, a palm scanner, or another type of biometric scanner. These scanners are also referred to as live print scanners. Live print scanners do not require the application of ink to a person's finger or palm. Instead, live print scanners may include a prism located in an optical path. A platen is used as the surface for receiving the biometric object. For example, with an optical fingerprint scanner, a finger is placed on the platen, and a camera detects an image of the fingerprint. The platen can be a surface of the prism or any other surface provided in optical contact with the prism. The fingerprint image detected at the camera is comprised of relatively light and dark areas. These areas correspond to the valleys and ridges of the fingerprint.

Live print scanners utilize the optical principle of total internal reflection (TIR). The rays from a light source internal to these optical scanners reach the platen at an incidence angle that causes all of the light rays to be reflected back. This occurs when the angle of incidence is equal to or greater than the critical angle, which is defined at least in part by the ratio of the two indices of refraction of the medium inside and above the surface of the platen.

In the case of a live fingerprint scanner, one or more fingers are placed on the platen for obtaining a fingerprint image. Ridges on a finger operate to alter the refraction index at the platen, thereby interrupting the TIR of the prism. This interruption in the TIR causes an optical image of the ridges and valleys of a fingerprint to be propagated through the receiving surface and captured by a camera internal to the device.

Live print scanners are increasingly being called upon to generate large area, high-quality images. One approach is to use an extremely large, high pixel count area image sensor. These area image sensors are very expensive and impractical.

### SUMMARY OF THE INVENTION

The present invention relates to large area scanners. The system in the present invention utilizes two or more image sensors mounted on a common sliding mechanical stage. One sensor is a two-dimensional X-Y array sensor (also called an area sensor) that is used to capture “preview” images of the large platen area. Another sensor is a linear array sensor (also called a line sensor).

The area sensor captures a preview of the image of the large platen area. This preview can be used to determine if an object on the platen is ready to be scanned prior to a higher quality or high resolution scan of the object. Further, since the area sensor is used to generate a preview, it need not be an expensive high-resolution area sensor. Moreover, the area sensor allows for higher frame rate and faster feedback of data.

The line sensor can generate a high quality image over a large platen area. The line sensor scans one axis of the platen at a desired resolution, including high resolution. The line sensor may also increase the quality of the image by eliminating distortion and/or blurring.

In operation, the mechanical stage is moved to a first position where the area sensor receives an image of the illuminated platen area. The area sensor detects the image, which is stored and processed as a preview image. This preview image is processed to determine whether scanning conditions are acceptable. If so, the stage is moved to a second position, where the line sensor can begin a scanning operation. During the scanning operation, the stage is moved relative to the platen so that the line sensor on the stage scans the platen area. Line-by-line scans of the platen area are obtained. This data is processed to obtain a high-quality image of the object.

In an embodiment, the platen is illuminated using a single illumination source. In another embodiment, a linear array of light emitting diodes (LEDs) is mounted on the sliding stage and is used to illuminate the platen.

Further embodiments, features, and advantages of the present invention, as well as the structure and operation of the various embodiments of the present invention are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a perspective view illustrating a large area, high-quality scanning apparatus, according to an embodiment of the present invention.

FIG. 2A is a block diagram illustrating further detail of the large area, high-quality scanning apparatus, according to the embodiment of the present invention shown in FIG. 1.

FIG. 2B is a diagram illustrating an illumination subsystem of the large area, high-quality scanning apparatus, according to an embodiment of the present invention.

FIG. 3A is a perspective view of a flat area illumination source of a platen of the large area, high-quality scanning apparatus, according to an embodiment of the present invention.

FIG. 3B is a perspective view of a linear array illumination source of a platen of the large area, high-quality scanning apparatus, according to another embodiment of the present invention.

The features, objects, and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

Introduction

While specific configurations and arrangements are described, it should be understood that this description is provided for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

Large Area, High Quality Palm Print Scanner Apparatus.

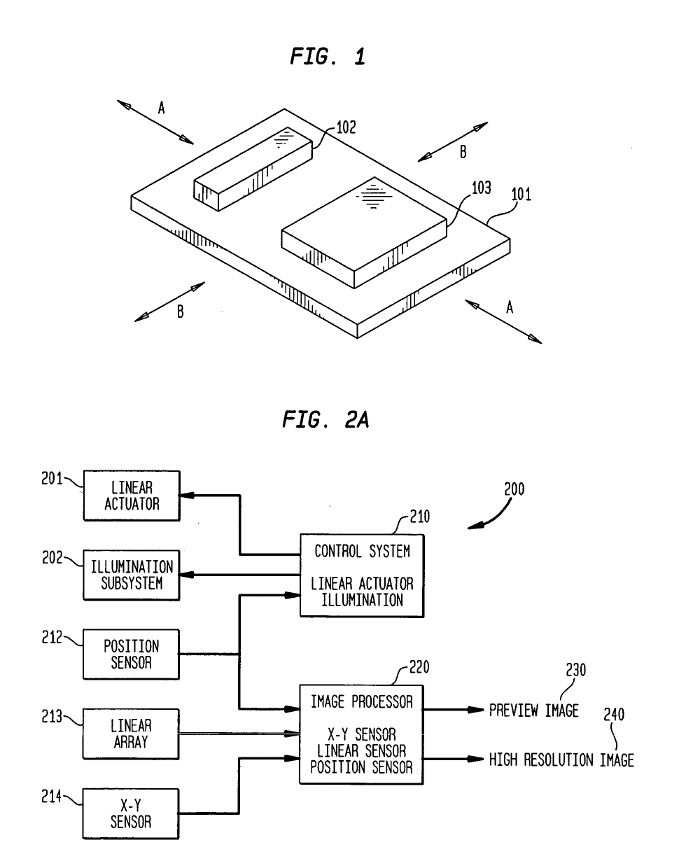

The present invention utilizes a combination of two or more image sensors mounted on a common sliding mechanical stage 101, as shown in FIG. 1. In the example embodiment of FIG. 1, a first sensor 103 and a second sensor 102 are shown mounted to stage 101. First sensor 103 is a two dimensional X-Y array of sensing elements. For instance, first sensor 103 can be a charged-coupled device (CCD) or another type of high quality sensor as would be known to a person skilled in the art. First sensor 103 is used to capture “preview” images of the large platen area. In an embodiment, this ensures proper object alignment on the platen prior to capture of a high quality image by second sensor 102. The preview image may also be used to check the field of view or clarity of the image. In an embodiment, first sensor 103 scans at a lower resolution, allowing the present invention to achieve a higher frame rate when scanning the object as well as faster feedback of image data from the platen surface.

Second sensor (or possibly several sensors) 102 is a linear array of image sensing elements, including a suitable number of pixels per inch. The linear array may be similar to a single row or column of CCD image capturing elements. Other linear image capturing devices known to persons skilled in the relevant arts may also be used. In an embodiment, the linear array is a high-quality sensor including at least 1000 pixels or dots per inch (“dpi”), although fewer or greater numbers of dpi can also be used by the present invention. In an embodiment, the high-quality aspect of second sensor 102 is a result of low-distortion capabilities.

Thus, second sensor 102 is considered high quality relative to first sensor 103, because relative to first sensor 103, second sensor 102 has one or more of a higher resolution (e.g., more dpi), lower distortion, greater contrast, better gray-scale and/or color differentiation, more uniform lighting, etc.

In an embodiment, a common set of optics is utilized to image the object on the mechanical stage such that either sensor subsystem (including first sensor 103 and second sensor 102) can view the image, depending on placement of the stage. In an embodiment, each sensor subsystem has its own set of lenses that move with the respective subsystem. In operation, the stage would be in a position to first place the X-Y sensor 103 at the image. This would permit the present invention to quickly scan the image to determine whether the object is ready to be scanned with the high quality sensor.

Once an acceptable preview image is obtained, the sliding stage 101 traverses the linear array of second sensor 102 through the image to obtain line-by-line scans of the image. In one implementation, during this period, the instantaneous position of sliding stage 101 is measured and recorded along with the output signals from the linear array of second sensor 102.

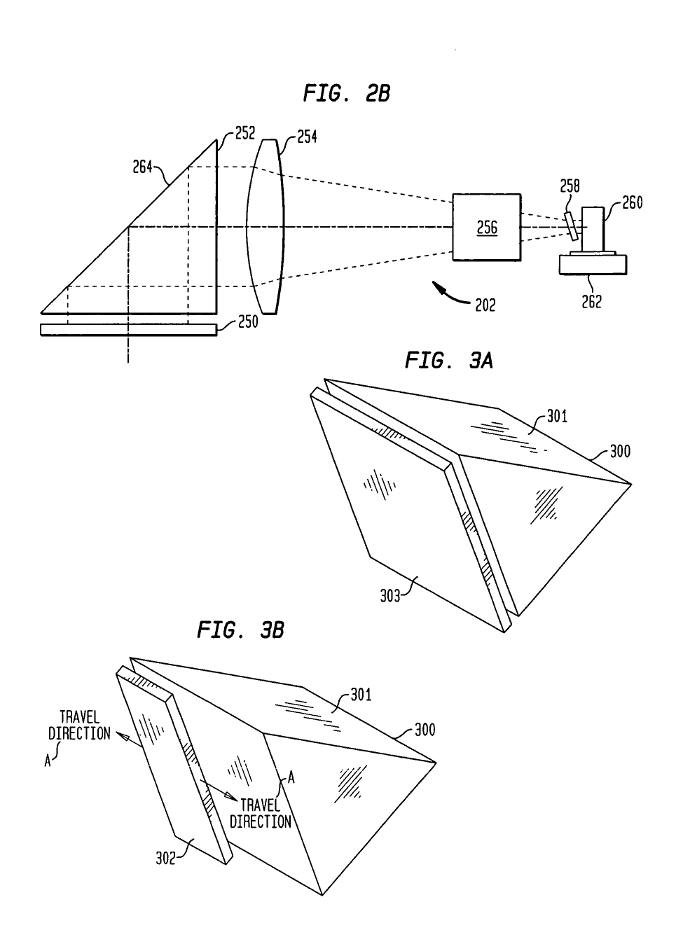

FIG. 2A is a block diagram of a processing system 200 according to an embodiment of the present invention. Processing system 200 processes pixel data output from linear array sensor 102 and associated position data to generate a high-quality image 240 of the object. In an embodiment, processing system 200 includes a linear actuator 201, an illumination subsystem 202, a control system 210, a position sensor 212, a linear array 213, an X-Y sensor 214, and an image processor 220. Control system 210 receives input data from position sensor 212, and outputs control signals to linear actuator 201 and illumination subsystem 202. Image processor 220 receives input data from position sensor 212, linear array 213 and X-Y sensor 214. Image processor 220 generates a preview image 230 and a high-quality image 240 using the input data. Linear array 213 is similar to second sensor 102 of FIG. 1. X-Y sensor 214 is similar to first sensor 103 of FIG. 1.

Position sensor 212 monitors the position of stage 101 and/or the positions of X-Y sensor 214 and linear array 213. In the current embodiment, linear actuator 201 controls the position of stage 101 shown in FIG. 1. For example, in response to control system 210, linear actuator 201 moves either of X-Y sensor 214 or linear array 213 into position to scan/capture an image. Furthermore when obtaining line-by-line image scans, linear actuator 201 moves stage 101 in a stepwise fashion, so that linear array 213 can capture each line scan.

FIG. 2B is a block diagram of illumination subsystem 202. Illumination subsystem 202 includes illuminator 250, prism 252, objective lens 254, lens group 256, image sensor 258, mechanical stage 260, and base 262. Prism 252 has a surface 264. In an embodiment, prism 252 has a right triangle cross-section. Surface 264 forms the surface of prism 252 that is opposite the right angle of prism 252. Light from illuminator 250 illuminates prism 252 through a first side, and reflects off prism surface 264. Prism surface 264 may also act as a platen to receive a biometric object. The reflected light is transmitted through a second side of prism 252, through objective lens 254 and lens group 256. Other optical arrangements can alternatively be used to transmit and focus the reflected light at image sensor 258. Image sensor 258 receives the reflected light. In an embodiment, image sensor 258 is a low-resolution area sensor, such as X-Y sensor 214. In another embodiment, image sensor 258 is a high-quality sensor, such as linear array 213. Image sensor 258 is mounted on mechanical stage 260. Mechanical stage 260 is further mounted on base 262. Mechanical stage 260 moves one of linear array 213 and X-Y sensor 214 into position to receive the reflected light. As would be understood by one skilled in the art, other embodiments of illumination subsystem 202 are possible.

FIGS. 3A and 3B illustrate different light sources for illuminator 250, according to example embodiments. In one embodiment, a single source 303 illuminates the entire platen, as shown in FIG. 3A. Single source 303 provides illumination evenly over the entire platen surface for use by the X-Y scanner.

In another embodiment, shown in FIG. 3B, a light source 302, which can include an array of light emitting diodes (LEDs), for example, is mounted on sliding stage 101. Light source 302 is mounted so that its light, when reflected by the platen surface, illuminates the linear array detector. Light source 302 can be utilized during the period when the high-quality linear array detector, such as linear array 213, is being swept across the image plane. Light source 302 can be adjusted in a manner to flatten the illumination intensity at the object plane during the high-quality scanning period.

Note that in embodiments, light source 302 can be an illumination source type other than a linear array, including being a single source or a two-dimensional array of light elements. Furthermore, light source 302 can include illumination elements other than LEDs, including lasers, incandescent lights, etc.

The systems and methods in the present invention can be used for capturing large area, high-resolution and/or forensic quality biometric images such as the fingers, toes, hands, and feet of human subjects. For example, the present invention could be used for capturing foot print images, including those of newborn children as commonly used for birth records.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A large area, high-quality scanning apparatus for scanning a biometric object, said apparatus comprising:
a stage assembly;
a first sensor, mounted on said stage assembly, wherein said first sensor is used to capture a preview image of the biometric object; and
a second sensor, mounted on said stage assembly, wherein said second sensor is used to capture a second image of the biometric object,
wherein said second image is of high quality relative to said preview image.

2. The apparatus of claim 1, wherein a proper alignment condition of the biometric object with respect to a platen area is determined by the preview image prior to capture of the high resolution image.

3. The apparatus of claim 1, wherein said second sensor is a high-resolution sensor.

4. The apparatus of claim 1, wherein said second sensor is a low-distortion sensor.

5. The apparatus of claim 1, further comprising:
an illumination source configured to illuminate at least a portion of the platen area.

6. The apparatus of claim 5, wherein said illumination source is a single source of illumination.

7. The apparatus of claim 6, wherein said illumination source illuminates the entire platen area.

8. The apparatus of claim 5, wherein said illumination source is an array of light emitting diodes.

9. The apparatus of claim 8, wherein said array illuminates a strip of the platen area.

10. The apparatus of claim 1, wherein said stage assembly is a sliding stage assembly.

11. The apparatus of claim 10, further comprising:
an optical assembly,
wherein said optical assembly is tuned for both the first sensor and the second sensor.

12. The apparatus of claim 11, said optical assembly comprising along an optical path:
an illumination source to produce light;
a prism that receives the biometric object and light from said illumination source;
an objective lens that receives reflected light from the prism; and
a lens group that processes the reflected light from the prism,
wherein a surface of said prism forms the platen area.

13. The apparatus of claim 10, further comprising:
at least one lens attached to one of said first and second sensors, whereby the at least one lens moves with the one of said first and second sensors.

14. A method of high-resolution scanning of a biometric object over a large platen area, said method comprising:
imaging the platen area in its entirety at low-resolution; and
scanning the area line-by-line at high resolution.

15. The method of claim 14, further comprising after said imaging step but before said scanning step:
determining a proper alignment condition of the biometric object with respect to a platen area.

16. The method of claim 14, further comprising before said imaging step:
illuminating the platen area in its entirety.

17. The method of claim 14, further comprising before said scanning step:
illuminating a strip of the platen area.
